(19) United States
(12) Patent Application Publication
(10) Pub. No.: US 2022/0371438 A1
(43) Pub. Date: Nov. 24, 2022

(54) AUTOMOBILE CONSTRUCTION WITH AIRPLANE REPRESENTATIVE FEATURES

(71) Applicant: Elizabeth Michea Danine Conley-Lepene, Saco, ME (US)

(72) Inventor: Elizabeth Michea Danine Conley-Lepene, Saco, ME (US)

(21) Appl. No.: 17/324,027

(22) Filed: May 18, 2021

(51) Int. Cl. B60K 35/00; B60N 2/56; B60N 3/00; B60N 2/75; B60K 37/02; B60N 2/865

(52) U.S. Cl. CPC B60K 35/00; B60N 2/56; B60N 3/002; B60N 2/767; B60K 37/02; B60N 2/865; B60R 7/04

(57) ABSTRACT

An automobile with a construct and components with an appearance of an airplane. The back seats, and optionally the front seats, are bench style, with armrests that may be rotated out of position and located at opposing sides of the seat when the seat is a two-person bench. For a three-person bench, there are intermediate armrests. The airplane-type seats include headrests integrated into the seat rather than being extendible from the top of the seat. The bench seat is removably affixed to an underlying support substrate, which may be substantially hollow and arranged to enable access to storage within the support substrate. The interior of the automobile of the present invention includes controllable lighting and air located above the passenger's head, either directly or to the side above a window. An instrument and control panel that supplies the driver with information and control expected for an automobile is configured with the appearance and content of an instrument and control panel a pilot would expect to see in an airplane. Controls are positioned sufficiently close to the driver to be accessed and employed as needed. Wheels of the automobile of the present invention are designed to give the appearance of the stators or rotors of an airplane jet engine.

### BACKGROUND OF THE INVENTION

### 1. Field of the Invention

The present invention relates to automobiles. More particularly, the present invention relates to automobiles having features primarily internally that give them the appearance of being aircraft.

### 2. Description of the Prior Art

The design of automobiles is a long and substantial activity throughout the world. The primary purpose of the automobile is to transport people and items from one location to another along roadways. That functionality is well established while continuing to evolve, particularly in the move from gas-powered to electric-powered vehicles. Substantial effort also goes into the interior and exterior design of automobiles. That effort seeks to combine form and function so that the automobile can be operated safely for its primary purpose while also providing the automobile inhabitants with a comfortable and pleasing environment while underway.

Present interior and exterior designs of automobiles are substantially similar in that they have readily recognizable common features from the seat construct to the instrument panel to wheels but not limited thereto. Given that most individuals who are permitted to drive an automobile are more likely than not to operate automobiles only, it makes sense to have common construct of the elements of the automobile with which they interact, or at least observe. However, there are some humans who operate other forms of transportation, with such other forms of transportation configured differently for form and function than are automobiles. These can include but not be limited to boats, motorcycles, and airplanes. It would be of interest to such individuals to have an automobile design that incorporates features that are common on the other forms of transportation but that may be different from conventional automobile design—without adversely impacting automobile operation. What is needed is a design of elements of an automobile that correspond at least in appearance to components of other forms of transportation. In particular, it would be desirable to have an automobile design that incorporates some features of an airplane.

### SUMMARY OF THE INVENTION

It is an object of the present invention to provide an automobile design that incorporates functional components having an appearance and, in some instances, similar functionality as provided by similar elements of an airplane. This object is achieved by integrating elements such as airplane seating, instrument panel appearance and function, and wheels that look as though they would fit with the design of an automobile.

The present invention is an automobile that has seats similar in design to those found in an airplane. A base automobile may be modified to include the features of the automobile of the present invention. The back seats, and optionally the front seats, are bench style, with armrests that may be rotated out of position and located at opposing sides of the seat when the seat is a two-person bench. The front seats may alternatively be bucket seats similar in construct to a pilot's seat but not limited to that. For a three-person bench, there are intermediate armrests. Further, the airplane-type seats include headrests integrated into the seat rather than being extendible from the top of the seat. Seatbelts extend from the interface between seat part of the bench and the back support portion of the seat. The bench seat is removably affixed to an underlying support substrate, which may be substantially hollow and arranged to enable access to storage within the support substrate. The interior of the automobile of the present invention includes controllable lighting and air located above the passenger's head, either directly or to the side above a window, as one would experience inside an airplane.

The driver compartment includes an instrument and control panel that supplies the driver with information and control expected for an automobile. However, the instrument and control panel is configured with the appearance of the format of an instrument and control panel a pilot would expect to see in an airplane. The instrument and control panel of the present invention is arranged about the steering wheel, which optionally may be designed like the yoke of an airplane. An information set is positioned above the driver's view of the steering wheel and shows fuel, speed, heading, and other information of interest to the driver but with airplane attributes. Adjacent or otherwise near the information set and the steering wheel are controls such as park, drive, reverse controls, interior temperature regulation, a video display, and a clock, but not limited thereto. The instruments and controls may also include radio on navigation, which may be incorporated into a video display that can have touchscreen capability, that can be oriented around for METAR, ATIS, and TAF. The controls are positioned sufficiently close to the driver to be accessed and employed as needed.

The wheels of the automobile of the present invention are designed to give the appearance of the stators or rotors of an airplane jet engine.

The automobile of the present invention has components that are provided to carry out the expected functioning of an automobile but with the appearance of an airplane. The present invention provides those individuals with an affinity to airplanes to get the feeling that they are in an airplane and operating an airplane, to an extent, without the expense and limitations associated with airplane flying.

### BRIEF DESCRIPTION OF THE DRAWINGS

FIG. 1 is a perspective view of a portion of the interior of the automobile of the present invention.

FIG. 2 is a front view of the instrument and control panel of the automobile of the present invention.

FIG. 3 is a side view of two wheels of the automobile of the present invention.

### DETAILED DESCRIPTION OF THE INVENTION

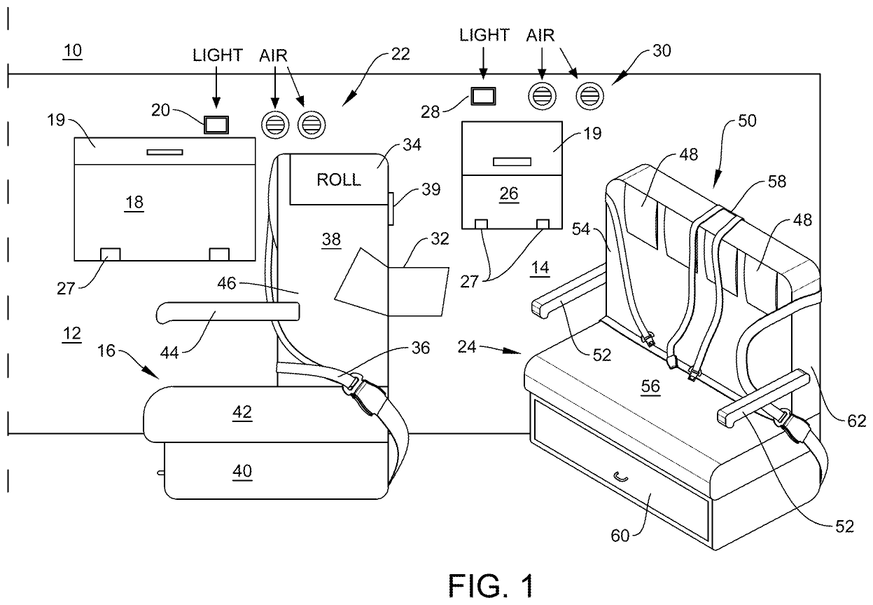

Components of an automobile of the present invention are shown in FIGS. 1-3. The automobile includes an interior passenger compartment 10 shown in FIG. 1. The interior passenger compartment 10 includes a forward section 12 and a rear section 14. The forward section 12 includes a front seat 16, a front passenger side front window 18, a front passenger side light 20, and a front passenger side air vent set 22. It is to be understood that there is a front driver side configuration with the same corresponding components. The rear section 14 includes a rear seat 24, a rear passenger side window 26, a rear passenger side light 28, and a rear passenger side air vent set 30. It is to be understood that there is a rear driver side configuration with the same corresponding components.

With continuing reference to FIG. 1, the front seat 16 includes a drop down tray holder 32, a head support roll 34, and a seat belt 36. The drop down tray 32 can be locked into an upright position and accessed by passengers in the rear section 14 as desired. The head support roll 34 can be adjusted forward and rearward but is otherwise an integral part of a back 38 of the front seat 16, such as one would experience in an airplane seat. The seat back 38 may also be incorporated therein one or more video screen 39, which may be used to provide updates on travel, as well as access to entertainment. The seat belt 36 is arranged to function as an airplane seatbelt does with a similar appearance while remaining in compliance with automobile seatbelt requirements. When the front seat 16 is of a bench configuration, there may be multiple ones of the seat belts 36. The front seat 16 further includes a storage locker 40 located below a seat 42 of the front seat 16. The storage locker 40 may be used to retain items of interest or safety to one or more passengers of the automobile. The front seat 16 also includes one or more arm supports 44 rotatably coupled to a side 46 of the front seat 16. A person may rotate the arm support 44 into a support position as shown or rotate it out of the way for access to a door to exit the automobile, for example.

The rear seat 24 includes a set of head support rolls 48 and a set of rear seat belts 50. There may be a tray holder in one or more of arm supports 52. Each of the set of head support rolls 48 can be adjusted forward and rearward but is otherwise an integral part of a back 54 of the rear seat 24, such as one would experience in an airplane seat. The set of rear seat belts 50 includes a plurality of individual rear seatbelts of selectable number dependent on the number of rear passengers positioned on seat portion 56 of the rear seat 24. A center rear seat belt 58 may be affixed and secured to a rear back portion of the rear seat 24. Each seat belt 58 is arranged to function as an airplane seatbelt does with a similar appearance while remaining in compliance with automobile seatbelt requirements. The rear seat 24 further includes a storage locker 60 located below the seat portion 56 of the rear seat 24. The storage locker 60 may be used in the same manner as is the storage locker 40 of the front seat 16. The one or more arm supports 52 are rotatably coupled to a side 62 of the rear seat 24. A person may rotate the arm support 52 into a support position as shown or rotate it out of the way for access to a door to exit the automobile, for example.

Each of windows 18 and 26 may be operated in a manner known for automobile windows. One or both of windows 18 and 26 includes a window shade 19, wherein each of window shades 19 are retained at an upper portion of the window 18/26 and extendible down to a deployed position at location 27. Window 18 is shown with the shade 19 in a raised position, and window 26 is shown with the window shade 19 partially deployed.

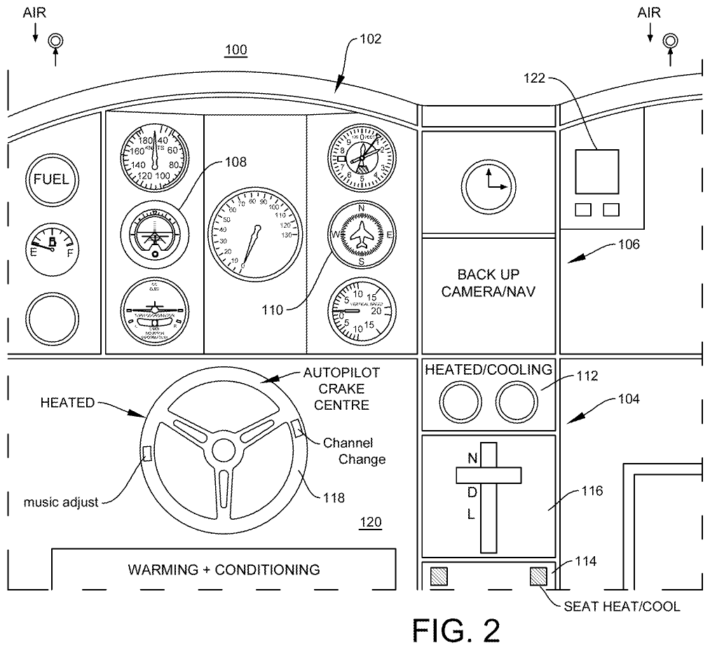

The automobile includes an instrument and control panel 100 shown in FIG. 2. The instrument and control panel 100 includes an instrument set 102, a control set 104, and an information set 106. The instrument set 102 includes representations of information of value and/or interest to the driver of the automobile including, but not limited to, fuel supply, speed, altitude, attitude, tachometer, and heading. One or more of the representations is configured in a manner known to those who pilot airplanes including attitude representation 108 and heading representation 110. The control set 104 includes controls to be managed by the automobile driver including interior heating and cooling controls 112, seat heating and cooling control 114, and transmission engagement control 116. Other controls may be included in the control set 104, including controls that may be associated with steering wheel 118. The steering wheel 118 may optionally be heated.

Space 120 about the steering wheel 118 may include other interior and exterior information including, for example, warming and conditioning status in the interior. Other information sources and controls may be deployed in the cabin area associated with the driver's space, including information about weather in the vicinity of the automobile as well as direct weather information relevant to an airplane pilot who may be driving the automobile to an airfield. That pilot/driver can access relevant flying information such as temperature, wind speed, and the like, such as through weather resource display 122.

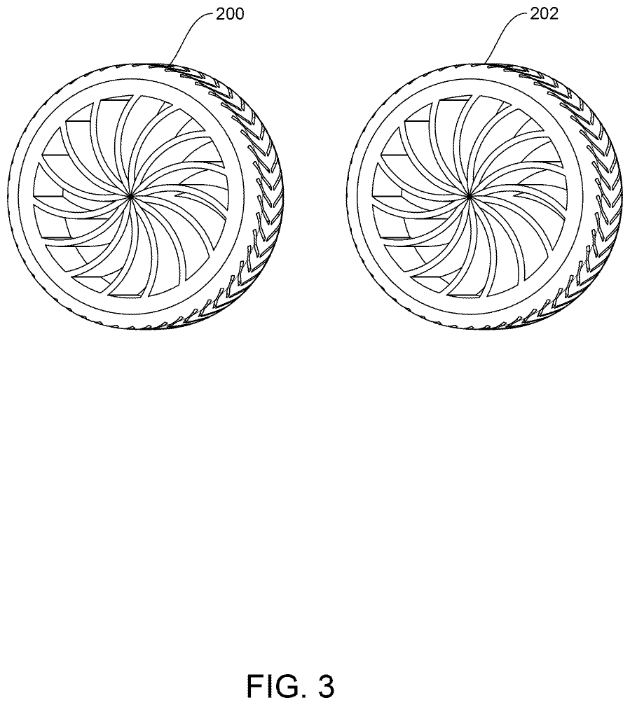

With reference to FIG. 3, the automobile includes a plurality of wheels (not shown). One or more of the plurality of wheels is configured with stators and/or rotors of an airplane engine, such as wheels 200 and 202. The automobile may include a hood that covers the engine compartment, wherein the hood may be retained in an open position to access the engine compartment using a stalk extending from an interior surface of the hood to a frame of the engine compartment.

The present invention is a modification of an automobile design to include a plurality of features that correspond to aspects of an airplane including seating, instruments and controls, and wheels, but not limited thereto.

What is claimed is:

1. An automobile with an interior passenger compartment, the automobile comprising:
a forward section including a front seat having a seat back, a front side window, a front side light, and a front side air vent set; and
a rear section including a rear seat having a seat back, a rear side window, a rear side light, and a rear side air vent set, wherein
the front seat includes a drop down tray holder, a head support roll, and a seat belt, wherein the drop down tray can be locked into an upright position and accessed by passengers in the rear section, wherein
the rear seat includes a head support roll and a seat belt, wherein
the head support roll of the front seat can be adjusted forward and rearward but is otherwise an integral part of the seat back of the front seat, and wherein
the head support roll of the rear seat can be adjusted forward and rearward but is otherwise an integral part of the seat back of the rear seat.

2. The automobile of claim 1, wherein the seat back includes one or more video screens incorporated therein, wherein the one or more video screens may be used to provide updates on travel, as well as access to entertainment.

3. The automobile of claim 1, wherein the front seat and the back seat each further includes a storage locker located below a seat thereof.

4. The automobile of claim 1, wherein the each of the front seat and the back seat includes one or more arm supports rotatably coupled to a side of the seat, wherein each of the one or more arm supports may be rotated from a support position out of the way for access to a door to exit the automobile.

5. The automobile of claim 1, each of the front side window and the rear side window includes a window shade, wherein each of window shades is retained at an upper portion of the window and extendible down to a deployed position.

6. The automobile of claim 1, further comprising an instrument and control panel having an instrument set, a control set, and an information set.

7. The automobile of claim 6, wherein the instrument set includes representations of information of value and/or interest to the driver of the automobile including, but not limited to, fuel supply, speed, altitude, attitude, tachometer, and heading, and wherein one or more of the representations is configured in a manner known to those who pilot airplanes including attitude representation and heading representation.

8. The automobile of claim 6, wherein the control set includes controls to be managed by the automobile driver including interior heating and cooling controls, seat heating and cooling control, and transmission engagement control.

9. The automobile of claim 1, further comprising a steering wheel and a space about the steering wheel, wherein the space includes automobile interior and exterior information including, warming, and conditioning status in the interior.

10. The automobile of claim 1, wherein a cabin area within the interior compartment includes information sources and controls, including information about weather in the vicinity of the automobile as well as direct weather information relevant to an airplane pilot who may be driving the automobile to an airfield including through a weather resource display that is configured to show relevant flying information including temperature and wind speed.

11. The automobile of claim 1, further comprising a plurality of wheels, each of which is configured with an engine appearance.

12. The automobile of claim 11, wherein each of the plurality of wheels has an appearance of airplane engine stators or rotors.

13. The automobile of claim 1, further comprising controllable lighting and air located above a passenger's head, either directly or to the side above the front side window and/or the rear side window.

14. The automobile of claim 1, further comprising a hood to cover and access an engine compartment, wherein the hood may be retained in an open position to access the engine compartment using a stalk extending from an interior surface of the hood to a frame of the engine compartment.
